(19) United States
(12) Patent Application Publication
(10) Pub. No.: US 2014/0358583 A1
(43) Pub. Date: Dec. 4, 2014

(54) SYSTEM AND METHOD FOR CONFIRMING THE IDENTITY OF A PATIENT

(71) Applicant: Lattice Incorporated, Wheaton, IL (US)

(72) Inventor: Brian K. Schwarz, Lake in the Hills, IL (US)

(21) Appl. No.: 13/908,167

(22) Filed: Jun. 3, 2013

(51) Int. Cl. G06Q 50/24; G06Q 10/00; G06Q 50/26

(52) U.S. Cl. CPC G06Q 50/24; G06Q 50/265; G06Q 10/00
USPC 705/3

(57) ABSTRACT

A computer-implemented method for confirming the identification of patient prior to a healthcare procedure includes the step of accessing a record for the patient in a database in response to scanning a characteristic or trait of a patient prior to a healthcare procedure, wherein the record includes a saved scan of the characteristic or trait of the patient. The method further includes the step of comparing the scan of the characteristic or traits of the patient with the saved scan of the characteristic or trait of the patient in the database.

### BACKGROUND

1. Field of the Disclosure

The present disclosure relates to systems and methods for identifying a patient and, more particularly, to systems and methods for confirming the identity of a patient.

2. Description of the Background

During a doctor visit or a hospital stay, patients are oftentimes required to leave a sample of urine, blood, stool, or other biological sample for analysis. In addition, in outpatient or inpatient scenarios, doctors, nurses, or other healthcare professionals may collect tissue, fluid, a foreign body, a tumor, or other pathology specimen for analysis. Whether a biological or a pathology specimen is collected, specific procedures must be followed to prevent contamination and to properly track the specimen as belonging to a particular patient.

During a prior art method for collection of biological and/or pathology specimens, a physician or other healthcare professional may determine that labwork is necessary. The physician then places an order for one or more tests. Prior to taking the specimen, a linear or two-dimensional barcode on a wristband that is attached to a wrist of the patient is scanned to perform a positive patient identification. Once the wristband is scanned, the system will utilize data communication from a hospital information system (HIS) or electronic medical record (EMR) to verify the identity of the patient. The user of the system, which is likely a healthcare professional, thereafter confirms the patient's identification. After the patient's identification has been verified, the healthcare professional proceeds with the collection of the specimen.

The above-described method of verifying the identification of a patient has its disadvantages. In particular, a patient may remove his/her wristband and another person may place the wristband on their wrist. Additionally, wristband barcode verification is often not possible in ambulatory, nursing home, or outpatient situations, as patients are frequently not provided with a wristband in those situations. Examples include a patient going to an ambulatory draw facility in a hospital, a patient having blood or urine taken in a doctor's office, or a patient having a mole removed in a dermatologist's office. Additionally, positive patient identification using barcoded wristbands is difficult in an operating room, as the patient's wrist is commonly draped and not accessible.

### SUMMARY

In illustrative embodiments, a computer-implemented method for confirming the identity of a patient prior to a healthcare procedure includes the step of accessing a record for the patient in a database in response to scanning a characteristic or trait of a patient prior to a healthcare procedure, wherein the record includes a saved scan of the characteristic or trait of the patient. The method further includes the step of comparing the scan of the characteristic or traits of the patient with the saved scan of the characteristic or trait of the patient in the database.

In further illustrative embodiments, a computer system for confirming the identity of a patient includes at least one processor, a network interface, and a memory element coupled to the processor. The memory stores instructions to direct the processor to perform operations including accessing a record for the patient in a database in response to scanning a characteristic of trait of a patient prior to a healthcare procedure, wherein the record includes a saved scan of the characteristic or trait of the patient. The memory further includes instructions to direct the processor to compare the scan of the characteristic or trait of the patient with the saved scan of the characteristic or trait of the patient in the database

In other illustrative embodiments, a non-transitory, computer readable storage medium storing a program performs a confirmation of an identity of a patient according to a process comprising the steps of accessing a record for the patient in a database in response to scanning a characteristic or trait of a patient prior to a healthcare procedure, wherein the record includes a saved scan of the characteristic or trait of the patient, and comparing the scan of the characteristic or trait of the patient with the saved scan of the characteristic or trait of the patient in the database.

### BRIEF DESCRIPTION OF THE DRAWINGS

FIG. 1 flow diagram depicting steps performed during a method of confirming an identity of a patient for a healthcare procedure using biometric information;

FIG. 2 is a schematic diagram of a system for implementing any of the methods of confirming the identity of a patient described herein; and

FIG. 3 is a flow diagram depicting steps performed during an exemplary method of collecting biometric information from a patient.

Other aspects and advantages of the present disclosure will become apparent upon consideration of the following detailed description, wherein similar structures have like or similar reference numerals.

### DETAILED DESCRIPTION

The present disclosure is directed to systems and methods for confirming patient identification during healthcare procedures. While the systems and methods of the present disclosure may be embodied in many different forms, several specific embodiments are discussed herein with the understanding that the present disclosure is to be considered only as an exemplification of the principles of the disclosure, and it is not intended to limit the disclosure to the embodiments illustrated.

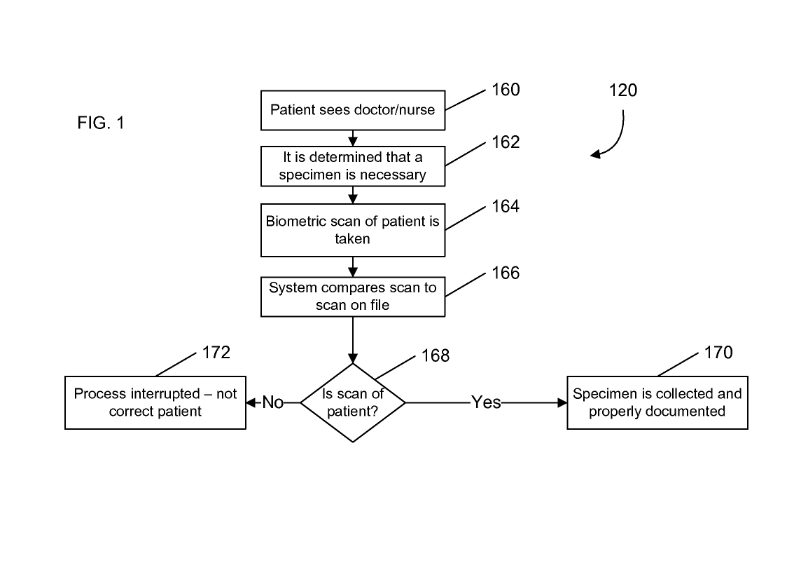

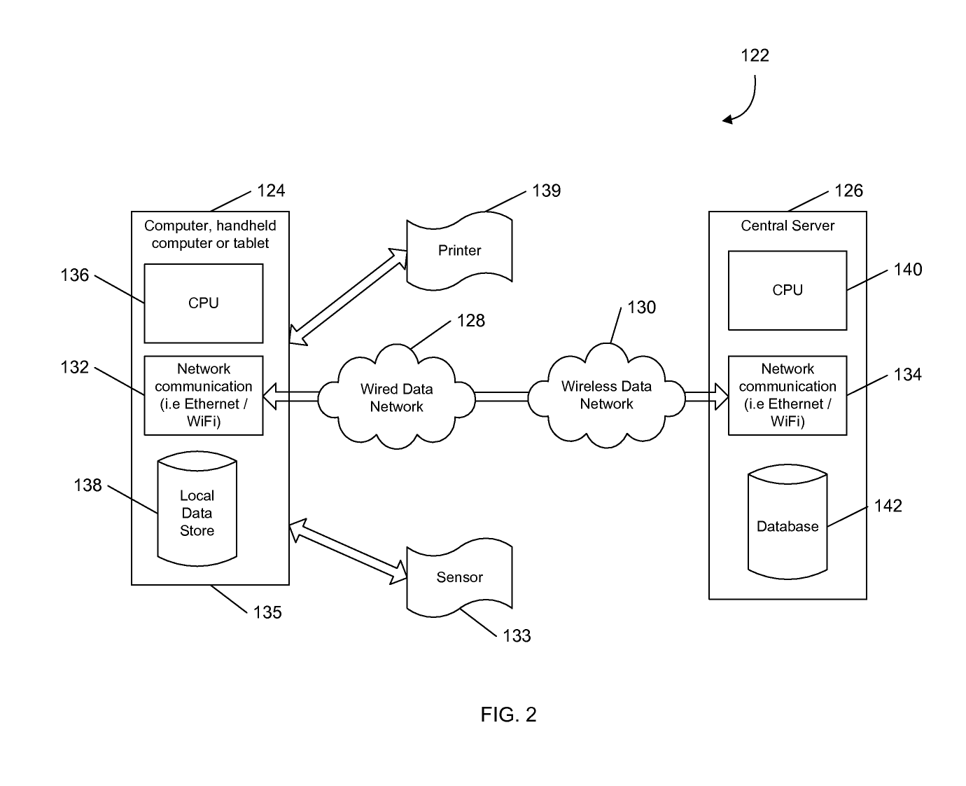

Referring to FIG. 1, a method of confirming the identity of a patient for a healthcare procedure 120 is depicted in the form of a flow diagram. The method may be utilized prior to a surgical procedure, collection of a specimen, transfusion administration, feeding (e.g., breast milk or meals) administration, medication administration, a surgical pathology specimen collection, or any other healthcare procedure. The method is at least partially implemented by a networked system 122, as seen in FIG. 2, which enables communication between one or more electronic platforms 124, for example, computers, handheld computers, tablets, and/or other electronic platforms and one or more central server 126. The system 122 may include any number of electronic platforms 124 connected through a wired data network 128 and/or a wireless data network 130 to each other and/or the central server 126. The wired data network 128 may be a global network, a wide area network, or a local area network. The wireless data network 130, which may be coupled to the wired data network 128, may include one or more wireless data networks, such as cellular networks, WiFi networks, Bluetooth networks, etc. The electronic platforms 124 and/or the central server 126 may be coupled to one or both of the wired data network 128 and the wireless data network 130 through a network communication device 132 within the electronic platform 124 and a network communication device 134 within the central server 126. In an illustrative embodiment, the electronic platforms 124 may couple to the wired data network 128 over wired connections and to the wireless data network 130 over wireless links. In this manner, the electronic platforms 124 may access the central server 126 through the wired data network 128 and/or the wireless data network 130.

Referring again to FIG. 2, each electronic platform 124, which may be, for example, a computer, a handheld computer, a tablet, or any other suitable electronic platform, may include a sensor or scanner 133 and a computer portion 135. The electronic platform 124 may also include an optional graphical user interface (not shown). The optional graphical user interface may include one or more input/output (I/O) devices, such as a touch screen, a keyboard, a stylus, a joystick, or any other suitable I/O device, which can be arranged in various manners and have different shapes or designs. The touch screen may be a liquid crystal display (LCD), a display screen, a plasma screen, a light emitting diode (LED), or any other screen capable of displaying text and/or images and/or allowing input of text. The computer portion may also include an I/O device, a central processing unit (CPU) 136 (i.e., a microprocessor), memory (not shown), and an optional local data store or database 138. The CPU 136 may be any computer-processing unit, including multi-processor or single processor configurations. The memory may include, without limitation, any one or a combination of volatile memory elements (e.g., random access memory (RAM, such as DRAM, SRAM, SDRAM, etc.)) and nonvolatile memory elements (e.g., ROM, hard drive, tape, CDROM, etc.). The memory may incorporate electronic, magnetic, optical, and/or other types of storage media, and may have a distributed architecture where various components are situated remote form one another, but may still be accessed by the CPU 136, such as cloud computing. The graphical user interface is coupled to the I/O device such that commands or data entered by a user through the graphical user interface will be forwarded to the I/O device, to the CPU 136, and then to the memory.

The sensor 133 is connected, either wirelessly or by a wired connection, to the electronic platform 124. As will be discussed in greater detail below, the sensor 133 may be in the form of a biometric sensor that is capable of scanning a physiological characteristic or trait of a patient, for example, a fingerprint, DNA, an iris, a retina, a palm vein, a palm, or any other characteristic or trait of a patient capable of scanning. The biometric sensor is used to match a biometric pattern that is part of a patient's medical record for purposes of positive patient identification during administration of healthcare procedures.

While the sensor 133 is shown as being connected to the electronic platform 124, the sensor 133 may be implemented within the electronic platform 124 or the sensor 133 may incorporate one or more of a CPU, network communication (i.e., Ethernet/WiFi), and/or a local data store, such that the sensor 133 may function independently of a separate electronic platform 124 (or instead of an electronic platform 124) and communicate directly with the central server 126. Still optionally, the sensor 133 may be connected directly to the central server 126. The sensor 133 may alternatively include any number of the components disclosed with respect to the electronic platform 124, thereby functioning as an electronic platform 124.

One or more portions of the method of confirming the identity of a patient for a healthcare procedure 120 as disclosed herein may be in the form of one or more executable programs stored within the memory that are run within the CPU 136 (or other hardware device) or may be accessed through an Internet website accessible from any location. If an Internet website is utilized, the Internet website may include any number of different security features. The one or more executable programs, if run within the CPU 136, may be implemented in software, firmware, hardware, or a combination thereof. The local data store 138 may store data related to specimens and/or any other data.

One or more portions of the method 120 may be embodied in any computer-readable medium for use by or in connection with an instruction execution system, apparatus, or device, such as a computer-based system, processor-containing system, or other system that may fetch the instructions from the instruction execution system, apparatus, or device and execute the instructions. In the context of this application, a “computer-readable medium” may be any means that may store, communicate, propogate, or transport the program for use by or in connection with the instruction execution system, apparatus, or device. The computer readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), a portable compact disc read-only memory (CDROM) (optical), and a portable USB storage device. In an illustrative embodiment, where the method 120 is implemented in hardware, it should be obvious that it may also be implemented with any, or a combination of, the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One or more electronic platforms 124 and/or sensors 133 may be connected, either wirelessly or through a wired connection, to a printer 139. Optionally or additionally, one or more of the electronic platforms 124 and/or sensors 133 may be connected to any other suitable peripheral devices, for example, a camera, a video camera, plotter, microphone, or any other suitable peripheral device.

Referring again to FIG. 2, the central server 126 further includes a CPU 140 and a central database 142. The electronic platform(s) 124 and/or sensor(s) 133 communicate via the wired data network 128 and/or the wireless data network 130 with the central server 126 through the network connections 132, 134, to transfer data to the central server 126 for processing within the CPU 140 and/or storage within the database 142. Data may also be transferred from the central server 126 to the electronic platform(s) 124 and/or sensor(s) 133 for displaying and/or processing by the electronic platform(s) 124 and/or sensor(s) 133.

While various components of the system 122 are disclosed, the system 122 may include any number of the depicted or additional electronic components and/or sensors, such as central processing units, monitors, printers, other peripheral device, and/or any other computer hardware or software.

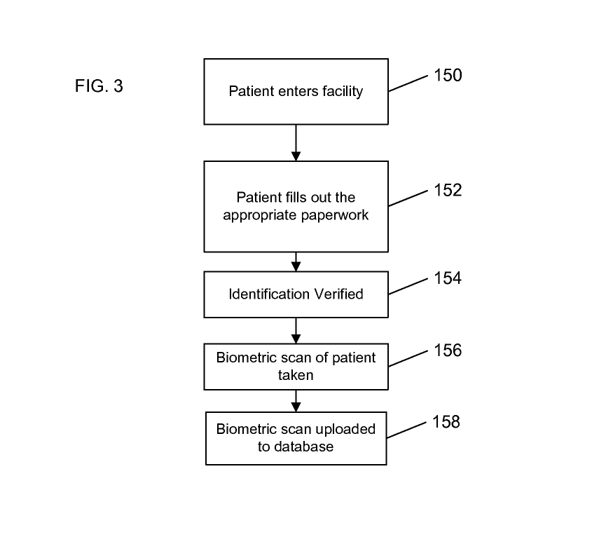

Prior to the method steps illustrated in FIG. 1, a biometric scan of a patient is taken and saved in the database 142 (and optionally the data store 138, if used) of the central server 126. In an illustrative embodiment, as seen in FIG. 3, a patient enters a healthcare facility (e.g., doctor's office, hospital, or other healthcare facility) at block 150 and is asked to fill out patient intake paperwork. The patient fills out the appropriate paperwork at block 152 and returns the paperwork to the reception or other intake area. The patient's identification is verified at block 154, for example, by checking a photo identification, such as a driver's license or passport. The patient's identification may additionally be checked by means of a birth certificate or other form of identification. Once the patient's identification has been verified, one or more biometric scans of the patient are taken at block 156 and the scans are uploaded into the database 142 at block 158 as part of a record for that patient. The patient's record may include any other information, for example, name, date of birth, address, phone number, insurance information, patient visits, procedures, or any other patient or visit information. As noted above, the biometric scan is saved within the database 142 (and optionally the data store 138, if used) and is associated with a record within the database 142 (and data store 138) for that patient. While a single biometric scan is referenced herein, any number of the same (i.e., multiple fingers) or different (i.e., fingerprint, DNA, etc.) biometric scans may be created, saved, and associated with a patient. While one process for intake of a patient and collection of biometric scans is described, other processes are envisioned. For example, a biometric scan may be taken at any visit and/or may be taken at a secure off-site facility or by a third party.

Referring again to the method 120 of FIG. 1, a patient visits a nurse, doctor, or other healthcare professional in an in-patient or out-patient facility at block 160. At block 162, it is determined by the healthcare professional that a healthcare procedure is necessary (of the patient has visited for the administration of a specific healthcare procedure). Prior to collection of the specimen, a real-time biometric scan of the patient is taken at block 164. In an illustrative embodiment in which a biometric scan of a fingerprint has been taken and stored in the database 142, for example through the method of FIG. 3, the real-time biometric scan is taken by placing one or more fingers of the patient on the sensor 133, at block 164. The electronic platform 124 and/or sensor 133 communicates with the central server 126 and directs the central server 126 to compare the real-time biometric scan with the biometric scan for that patient that is saved in the database 142 (and/or local data store 138), at block 166. Referring to block 168, if the real-time biometric scan matches the biometric scan for the patient in the database 142, the system directs the healthcare professional to collect the specimen and the specimen is collected at block 170. If the real-time biometric scan does not match the biometric scan for the patient in the database 142, the process is interrupted and the system directs the healthcare professional not to collect the specimen until the patient is properly authenticated. If the real-time biometric scan does not match the biometric scan saved in the database, the method/system may alternatively display a message to the user, lock the system, or indicate in any other suitable manner that a match has not occurred and the healthcare professional should not proceed with the healthcare procedure. The system/method may additionally or alternatively include one or more means for preventing the healthcare professional from proceeding with the healthcare procedure.

Once the identity of the patient has been confirmed, the system may perform any number of functions. In an illustrative embodiment, the electronic platform 124 may display a list of open healthcare procedures for a patient, for example, including one or more surgical procedures, specimen collections, transfusion administrations, medication administration orders, feeding administration, a surgical pathology specimen collection, or any other healthcare procedures. In this manner, a healthcare professional may select the appropriate open healthcare procedure for administration and proceed with such procedure.

If a specimen is collected during the method 120, the specimen is placed in a container and a linear or two-dimensional barcode is attached to the container, as described in greater detail in U.S. application Ser. No. 13/771,971, entitled “System and Method for Inputting Medical Information” and filed Feb. 20, 2013, and U.S. application Ser. No. 13/740,722, entitled “System and Method for Pathology Specimen Collection” and filed Jan. 14, 2013, the disclosures of which are hereby incorporated by reference in their entireties. The specimen is thereafter routed to a laboratory or through other appropriate personnel or departments for testing thereof. The barcode includes information associated with the patient and/or the specimen and is associated with the patient.

The methods 120 disclosed herein for positive patient identification may be used in any healthcare situation. For example, the methods 120 may be implemented in a situation wherein a patient is admitted on an inpatient basis as a replacement for or in addition to the use of existing wristbands. Additionally, the method may be implemented in situations where a patient does not receive a wristband or other identification means, such as in outpatient or ambulatory situations.

Any of the principles herein may be used with respect to positive patient identification for any healthcare procedure. Examples of when positive patient identification might be necessary include, but are not limited to, specimen (e.g., blood, urine, microbiology, pathology, etc.) collection, surgical procedures, transfusion administration, breast milk feeding, feeding administration, medication administration, a surgical pathology specimen collection, and patient meal matching.

The biometric scans discussed herein may be either may be of a physiological biometric, as discussed in detail above, for example, of a fingerprint, DNA, an iris, a retina, a palm vein, a palm, a geometry of a characteristic, face recognition, a facial thermogram, an odor or scent, an ear canal, or any other physiological characteristic or trait. The biometric scans may alternatively or additionally be of a behavioral biometric, for example, a typing rhythm, gait, voice, voice, or any other behavioral characteristic or trait.

Any of the embodiments described herein may be modified to include any of the structures or methodologies disclosed in connection with other embodiments.

Numerous modifications to the present disclosure will be apparent to those skilled in the art in view of the foregoing description. Accordingly, this description is to be construed as illustrative only and is presented for the purpose of enabling those skilled in the art to make and use the embodiments of the disclosure and to teach the best mode of carrying out same. The exclusive rights to all modifications which come within the scope of the appended claims are reserved.

We claim:

1. A computer-implemented method for confirming the identity of a patient prior to a healthcare procedure, the method comprising the steps of:
accessing a record for the patient in a database in response to scanning a characteristic or trait of a patient prior to a healthcare procedure, wherein the record includes a saved scan of the characteristic or trait of the patient; and
comparing the scan of the characteristic or traits of the patient with the saved scan of the characteristic or trait of the patient in the database.

2. The computer-implemented method of claim 1, further including the steps of:
if the scan does not match the saved scan in the database, indicating to a user of a system implementing the method that the scan does not match the saved scan and the user should not proceed with the healthcare procedure; and
if the scan matches the saved scan in the database, allowing the user of the system to proceed with the healthcare procedure.

3. The computer-implemented method of claim 1, wherein the healthcare procedure is selected from the group consisting of: a surgical procedure, a specimen collection, a transfusion administration, a feeding administration, a surgical pathology specimen collection, and a medication administration.

4. The computer-implemented method of claim 1, wherein the characteristic or trait of the patient is selected from the group consisting of: a fingerprint, a palm, DNA, an iris, a retina, or a palm vein.

5. The computer-implemented method of claim 1, further including the steps of:
scanning the characteristic or trait of the patient;
saving the scan in the database prior to administration of the healthcare procedure.

6. The computer-implemented method of claim 5, wherein the scanning and uploading steps are performed in a process separate from the scanning, accessing, and comparing steps.

7. The computer-implemented method of claim 1, wherein the characteristic or trait of the patient is a behavioral characteristic or trait.

8. A computer system for confirming the identity of a patient, the computer system comprising:
at least one processor;
a network interface;
a memory element coupled to the processor, the memory storing instructions to direct the processor to perform operations comprising:
accessing a record for the patient in a database in response to scanning a characteristic of trait of a patient prior to a healthcare procedure, wherein the record includes a saved scan of the characteristic or trait of the patient; and
comparing the scan of the characteristic of trait of the patient with the saved scan of the characteristic or trait of the patient in the database.

9. The computer system of claim 8, wherein the memory element further includes instructions to direct the processor to perform operations comprising:
if the scan does not match the saved scan in the database, indicating to a user of a system implementing the method that the scan does not match the saved scan and the user should not proceed with the healthcare procedure; and
if the scan matches the saved scan in the database, allowing the user of the system to proceed with the healthcare procedure.

10. The computer system of claim 8, wherein the healthcare procedure is selected from the group consisting of: a surgical procedure, a specimen collection, a transfusion administration, a feeding administration, a surgical pathology specimen collection, and a medication administration.

11. The computer of claim 8, wherein the characteristic or trait of the patient is selected from the group consisting of: a fingerprint, a palm, DNA, an iris, a retina, or a palm vein.

12. The computer system of claim 8, wherein the memory element further includes instructions to direct the process to perform operations comprising:
in response to scanning the characteristic or trait of the patient in a procedure prior to the scanning step of claim 7, saving the scan in the database prior to administration of the healthcare procedure.

13. The computer system of claim 12, wherein the scanning and uploading steps are performed in a process separate from the scanning, accessing, and comparing steps of claim 7.

14. The computer system of claim 8, wherein the characteristic or trait of the patient is a behavioral characteristic or trait.

15. A non-transitory, computer readable storage medium storing a program for performing a confirmation of an identity of a patient, according to a process comprising the steps of:
accessing a record for the patient in a database in response to scanning a characteristic or trait of a patient prior to a healthcare procedure, wherein the record includes a saved scan of the characteristic or trait of the patient; and
comparing the scan of the characteristic or traits of the patient with the saved scan of the characteristic or trait of the patient in the database.

16. The non-transitory, computer readable storage medium of claim 15, further comprising the steps of:
if the scan does not match the saved scan in the database, indicating to a user of a system implementing the method that the scan does not match the saved scan and the user should not proceed with the healthcare procedure; and
if the scan matches the saved scan in the database, allowing the user of the system to proceed with the healthcare procedure.

17. The non-transitory, computer readable storage medium of claim 15, wherein the healthcare procedure is selected from the group consisting of: a surgical procedure, a specimen collection, a transfusion administration, a feeding administration, a surgical pathology specimen collection, and a medication administration.

18. The non-transitory, computer readable storage medium of claim 15, wherein the characteristic or trait of the patient is selected from the group consisting of: a fingerprint, a palm, DNA, an iris, a retina, or a palm vein.

19. The non-transitory, computer readable storage medium of claim 15, further including the step of:
in response to scanning the characteristic or trait of the patient, saving the scan into the database prior to administration of the healthcare procedure,
wherein the scanning and uploading are performed in a process separate from the scanning, accessing, and comparing steps.

20. The non-transitory, computer readable storage medium of claim 15, wherein the characteristic or trait of the patient is a behavioral characteristic or trait.
